(19) United States
(12) Patent Application Publication
(10) Pub. No.: US 2014/0046462 A1
(43) Pub. Date: Feb. 13, 2014

(54) Home Automation System on the base of Command Device that includes Internal Sockets and Dimmers

(71) Applicant: Maxym Mets, Dnepropetrovsk (UA)

(72) Inventor: Maxym Mets, Dnepropetrovsk (UA)

(21) Appl. No.: 13/964,081

(22) Filed: Aug. 11, 2013

(30) Foreign Application Priority Data
Aug. 12, 2012 (IL) 221426

(51) Int. Cl. G05B 15/02

(52) U.S. Cl. CPC G05B 15/02
USPC 700/90

(57) ABSTRACT

A home automation system comprising of a command device that includes multiply sensors to control and monitor environment, inner sockets, inner dimmers and a weather sensor. The inner sockets and dimmers are designed to be concealed inside the standard holes in the walls of the house in which are installed the standard sockets and switches whose manner of operation they are meant to control. Namely, in a manner that allows installation of the system even other than during construction or renovation of the house. The ZigBee transceivers also serve as a relay station of the ZigBee wireless transmissions of the system.

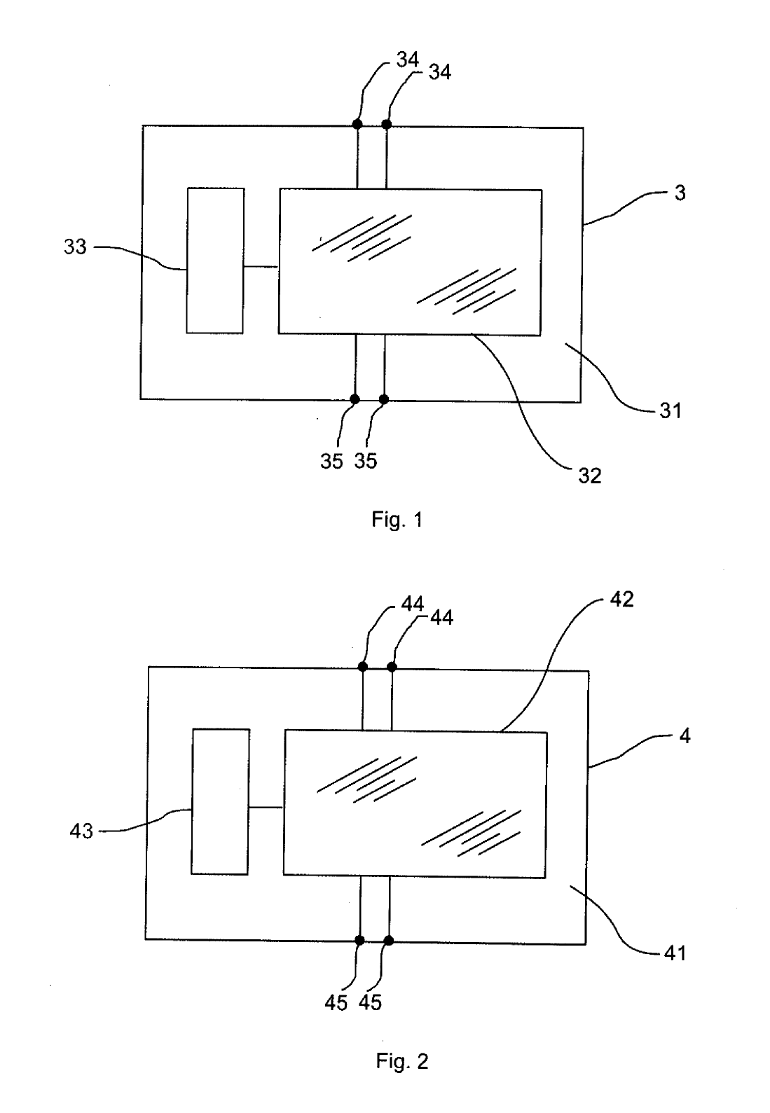

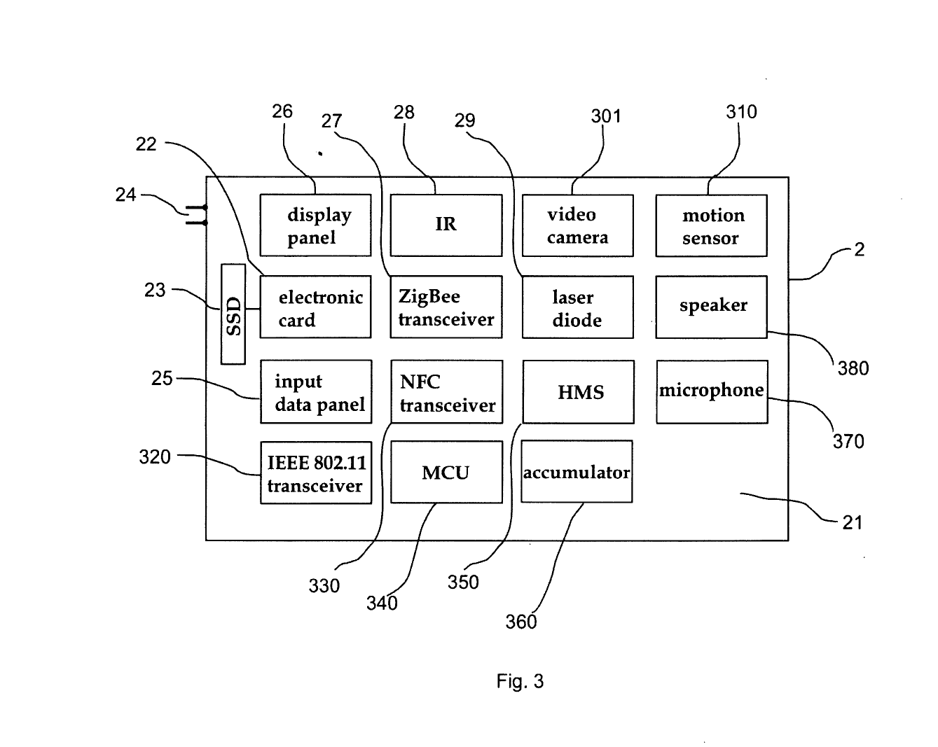

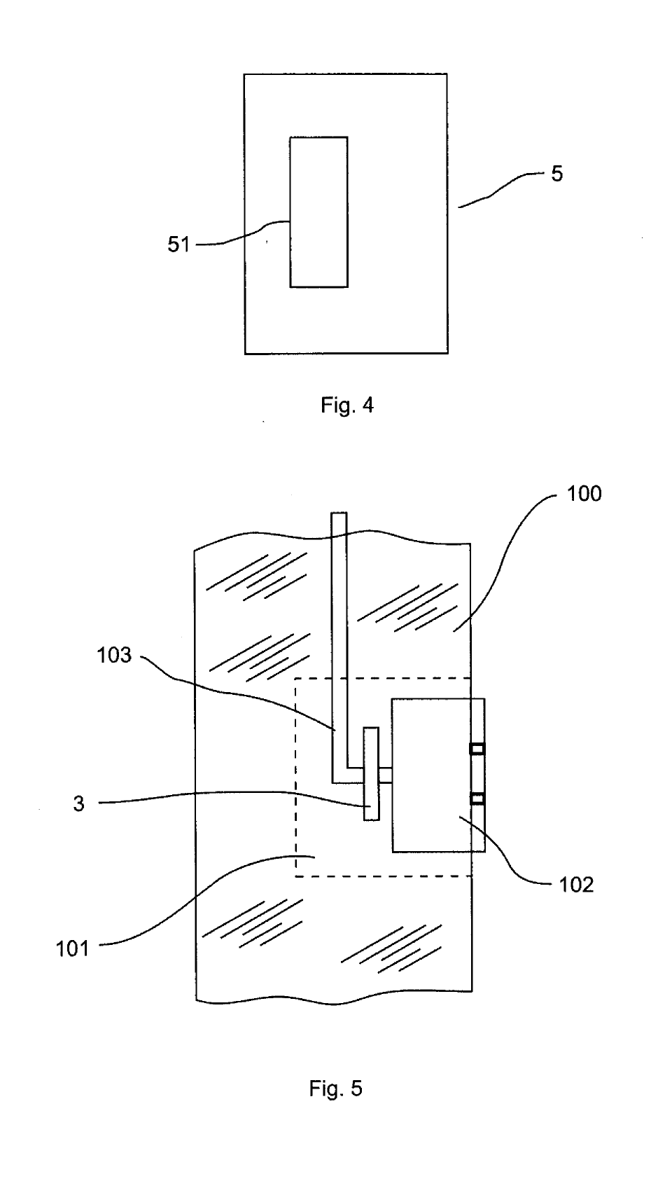

### THE FIELD OF THE INVENTION

The present invention concerns a home automation system on the base of command device that includes multiply sensors to control and monitor environment, internal sockets and dimmers that can be fitted and integrated into the walls of the house at any time and not necessarily at the time of building or renovating the house.

### PRIOR ART

There exist on the market advanced home automation systems that enable remote control, supervision and monitoring over the electric systems in the house, and in fact in any structure in which there are electric appliances. Mostly, it is common to use a home automation system for remote control over illumination systems, the air-conditioning system, and the home electronics devices such as television sets, home cinema system and such-like electric devices and other electrical devices. A home automation system enable turning off and on of electric devices, turning off, on and dimming of illumination and in general command over electric devices and means of illumination as above. The use of a home automation system enable savings in electricity consumption, safety for the electric devices and the general equipment in the house, and confers a prestigious aura and elegance on the house. A home automation system consists in most cases of a central command device, unique sockets and dimmers and communication between these components.

The home automation systems that currently exist in the market can be fitted and installed in houses during construction or during a thorough renovation of the house, in order to enable integration of the system's components inside the walls. in addition, fitting and installation of currently existing home automation systems require the use of professionals and also coordination and organization between the professional meant to install the system and the professionals dealing with construction or with renovating the house. Moreover, the components of the existing systems require the replacement of standard sockets and switches in the house and sometimes also in additional wiring in the electric ducts. Clearly, therefore, the installation of existing home automation systems is especially expensive, unwieldy and can be carried out in cases of construction or of renovation of the house.

The invention subject matter of the present patent application relates to a unique and innovative home automation system designed to provide a solution to the problems described above efficiently, conveniently and relatively cheaply.

### LIST OF DRAWINGS

The drawings attached to the application are not intended to limit the scope of the invention and the manner of its implementation. The drawings are designed only to visualise the invention and constitute one option among many others for its implementation.

Drawing 1 describes schematically the inner socket (3).

Drawing 2 describes schematically the inner dimmer (4).

Drawing 3 describes schematically the command device (2).

Drawing 4 describes schematically the weather sensor (5).

Drawing 5 describes schematically a cross-section of the inner socket (3) fitted inside the wall (100).

### DETAILS OF THE INVENTION

The object of the present is to provide a Home Automation System that can be installed and fitted at a house at any time and not only during construction or renovation of the house. A further object of the present patent application is to provide a system as above whose sockets and dimmers are integrated inside the walls of the house with no need to replace the standard sockets and switches in the house. In addition, the present invention is designed to provide a home automation system that an ordinary person can install and fit in the house with no special need for a professional.

The basic components of the system (1): The Home Automation System that is the object of the present invention shall be referred to hereunder as “the System” (1). The System (1) comprising of the following central components: command device (2), one or more inner sockets (3) and one or more inner dimmers (4). Furthermore, the system (1) may in addition include a weather sensor (6).

The inner socket (3) comprising of a case (31) that contains an electronic card (32), a ZigBee transceiver that includes an antenna (33), an incoming electric connection (34) and an outgoing electric connection (35). Each particular inner socket (3) has a unique ID code. The electronic card (32) can disconnect and connect the internal electric connection. In addition, the electronic card (32) can include an option for measuring the current intensity and the voltage and can also include a component for protecting the relevant electric device in the event of a power cut. The inner socket (3) can operate efficiently at powers of up to 3,500 watt. It is possible and desirable for the case (31) to be made of silicone or any type of rubber such that it is cast onto the internal components of the inner socket (3). The inner socket (3) may be in a variety of dimensions although it is desirable and possible for it to have approximately the following dimensions: thickness 1 cm, width 3 cm and length 4 cm. Drawing number 1 describes schematically the inner socket (3) and the main components inside it.

The inner dimmer (4) is made up in general like the inner socket (3) and comprising of a case (41) that contains an electronic card (42), a ZigBee transceiver that includes an antenna (43), an incoming electric connection (44) and an outgoing electric connection (45). Each particular inner dimmer (4) has a unique ID code. The electronic card (42) can disconnect and connect the internal electric connection and also allows the electric voltage to be changed, and as a result of that allows the intensity of illumination to be dimmed and controlled. In addition, the electronic card (42) can include an option for measuring the current intensity and the voltage and can also include a component for protecting the relevant electric device in the event of a power cut. The inner dimmer (4) can operate efficiently at powers of up to 500 watt. It is possible and desirable for the case (41) to be made of silicone or any type of rubber such that it is cast onto the internal components of the inner dimmer (4). The inner dimmer (4) may be in a variety of dimensions although it is desirable and possible for it to have approximately the following dimensions: thickness 1 cm, width 3 cm and length 4 cm. Drawing number 2 describes schematically the inner dimmer (4) and the main components inside it.

The command device (2) constitutes in effect the brain, vision and hearing of the system (1), as well as asset of wireless interface to communicate with outer devices, and it comprising of a case (21), an electronic card (22), a IEEE 802.11 transceiver (320), ZigBee transceiver (27), a infrared transceiver (28), a video camera (301), a accumulator (360), a motion sensor (310), a speaker (380) and a microphone (370), a solid-state disk (23), a connection to the electricity system (24). The command device (2) may include input data panel (25) and also a display panel (26). The electronic card (22) includes operating software that allows the relevant commands to be executed. The command device (2) may also include an internal clock. Furthermore, the command device (1) may in addition include a near field communication transceiver (330), a mobile communication transceiver (340), a laser diode (29), a heat monitoring sensor (350). Drawing number 3 describes schematically the command device (2) and the main components inside it.

The weather sensor (5) is designed to measure the outdoor temperature, humidity and state of the light or darkens outside and it also includes a transceiver that includes an antenna (51). The weather sensor (5) has a unique ID code. Drawing number 4 describes schematically the weather sensor (5) that includes a transceiver with an antenna (51).

The communication manner of the system (1) components: The command device (2) is connected by wireless communication via IEEE 802.11 transmission or any other transmission that exists or will exist in the future with the modem in the house—hereinafter “base wireless communication”. Moreover, the ZigBee transceiver (27) in the command device (2) communicates by ZigBee-wireless communication with the transceivers (33), (43) and (51) in the inner sockets, in the inner dimmers, in the weather sensor (5). In this manner, the command device (2) can send commands to the inner sockets, to the inner dimmers and to the sensor in order to control the relevant electric and illumination devices. As mentioned above, each inner socket (3), each inner dimmer (4) and the sensor (5) has an internal ID code such that it is possible to control which of them the command device (2) wishes to control at any given moment. In order to increase the communication range between the inner sockets (3), the inner dimmers (4) and the sensor (5) with the command device (2), each of the transceivers (33), (43) and (51) serves also as a relay station that increases the operational range of the system (1).

The manner of fitting the system (1) components: The system (1) is fitted in the home in such a way that the command device (1) is connected to the ceiling or is placed in any other accessible location at home and it is connected to an electric voltage source. The inner socket (3) is fixed in the wall (100) inside the hole (101) in which a standard socket (102) is mounted in the house. Any electric device connected to the electricity by means of a standard electric socket (102) can be made to be monitored and controlled by the system (1) by fixing and fitting inside the relevant hole (102) in the wall (100) the inner socket (3) which is connected by electric connection between the electric wires (103) and the standard socket (102). The fitting of the inner socket (3) inside the wall (100) is inherently simple and even a non-professional can do this easily and simply in the following manner: first remove the standard socket's cover, extract the standard socket (102) from the hole (101), disconnect the wires (103), connect the wires (103) to the incoming connection (34) in the inner socket (3) and connect the outgoing wires (35) to the standard socket (102). Thereafter, conceal the sockets (3) and (102) in the hole (101), tighten and close the cover on the standard socket (102). Drawing number 5 describes schematically the wall (100) inside which an inner socket (3) is fixed, being connected on one side (34) to the electric wires (103) and on the other side (35) to the standard socket (102). In the same manner, the inner dimmers (4) are also installed and integrated inside the hole in which the standard switch is located that controls the light fixtures one wishes to control by means of the system (1). The dimensions of the sockets (3) and the dimmers (4) make it possible to conceal them inside the hole (101) together with the standard socket or switch.

The weather sensor (5) is positioned outdoors and preferably attached to the window, in order to make possible good ZigBee-wireless communication with the command device (2).

The user can control remotely via ZigBee communication each of the inner sockets (3), each of the inner dimmers (4), and can control the electronic devices by infrared remote control and whose details have been fed into the infrared sensor (28). Controlling the inner sockets (3) means the ability to turn off and/or on the electric device whose electric plug is connected to the standard socket (102) after which the inner socket (3) is installed. Controlling the inner dimmers (4) means the ability to turn off and/or on and/or dim the illumination controlled by means of the standard switch after which the inner dimmer (4) is installed. The user can control the system (1) by means of the Internet or mobile communication from any computer or smart phone and such-like. When the user is at home or close to it he can control the system (1) by means of the IEEE 802.11 transmissions in the house. The fact that the system (1) includes a weather sensor (5) and an internal clock makes possible programming of the system (1) such that it turns on and off electric devices and also turns on, turns of or dims illumination in accordance with the state of the weather and the hours of darkness at any given moment or according to predefined times.

The system (1) can be programmed to operate automatically in a wide variety of options: turning on illumination or closing electric gates and doors when the sensor (5) detects darkness; dimming the illumination after a particular period of time according to information arriving from the sensor (5) and from the internal clock in the command device; covering roofs and balconies operating on electric motors when it starts raining when the sensor (5) detects a sharp increase in humidity which constitutes an indication of raining; controlling the intensity of operation of air-conditioners or home heating systems in accordance with the temperature that the sensor (5) measures and such-like. In addition, programmed system can control video camera (301) to capture, compress and record video image on the solid-state disk (23) of the system or send it to storage in intranet or Internet networks, to smart phone or computer of user, independently to observe for people that are on a visibility zone, to start video capture if motion detected or need to videoconference, by the instrumentality of the system (1) to recognize with the pattern objects or people. Video camera (30) and laser diode (29) both can be used as means to scan three-dimensional space of housing, which data can be recognised by system (1), and can be sent to a smart phone or a computer of the user, or stored on a solid-state disk (23) or on the network storage. The system (1) has an accumulator (360) to secure isolated energy supply in case of lack of electricity, a near field communication transceiver (330) to exchange information to and from smart phone or tablet PC, mobile communication (standard GSM or series of IMT-2000) transceiver (340) to connect with smart phone or tablet PC of user, has a speaker and a microphone for videoconferencing. Of course, in addition to automated control that the user predefines and modifies from time to time there is permanent and continuous remote control by means of computers or a smart phone.

Using the system (1) that is the subject matter of the present invention has many inherent advantages that are described above. In addition to the abovementioned advantages, using the system (1) provides the user with additional advantages, inter alia: the user can purchase the system (1) as a kit for self-installation and as an off-the-shelf product and install the system (1) without any need for an expert professional; the software that operates the system (1) can be installed in the user's computers and smart phone and downloaded from a dedicated website or in any other common way; the system (1) provides protection to the electric devices in the event of power cuts; the system (1) transmits to the user information about the rate of power consumption of the relevant devices. The system (1) can be installed at any time such that the inner sockets and dimmers are concealed inside the wall and not necessarily during construction or renovation of the house. In the light of all these, it is evident that the system's installation is easy, quick and simple and the installation cost is relatively cheap.

1. A home automation system comprising of a command device, one or more inner sockets, one or more inner dimmers; wherein the command device comprising of a case, an electronic card, a ZigBee transceiver, a infrared transceiver, a video camera, an accumulator, a motion sensor, a speaker and a microphone , a solid-state disk, a connection to the electricity system, operating software and a base wireless connection to a modem; wherein the inner socket comprising of a case that contains an electronic card, a transceiver that includes an antenna, an incoming electric connection and an outgoing electric connection; wherein the inner socket is designed to be concealed inside the standard hole in the wall of the house in which is installed the standard socket whose manner of operation said inner socket is meant to control; wherein the inner dimmer consists of a case that contains an electronic card, a transceiver that includes an antenna, an incoming electric connection and an outgoing electric connection; wherein the inner dimmer is designed to be concealed inside the standard hole in the wall of the house in which is installed the standard switch whose manner of operation said inner dimmer is meant to control; wherein the command device is connected by base wireless communication with the modem and with the ZigBee transceivers that are in the inner sockets, in the inner dimmers and in the weather sensor; in a way that enable the operation of the command device to be controlled by means of a cellular device or a computer by base wireless communication, by mobile communication or by means of the Internet and in a way that enable control of the system;

2. The system described in claim 1, wherein that additionally it includes a weather sensor that includes a ZigBee transceiver that includes an antenna.

3. The system described in claim 1, wherein that additionally the electronic cards include a component that measure the level of current and voltage and a component for protecting the electric devices in the even of a power cut.

4. The system described in claim 1, wherein that additionally the said ZigBee transceivers serve as a relay station of the ZigBee wireless transmissions of the command device.

5. The system described in claim 1, wherein that additionally the said command device includes a near field communication transceiver, a mobile communication transceiver, a laser diode, a heat monitoring sensor.
